(19) United States
(12) Patent Application Publication
(10) Pub. No.: US 2023/0398491 A1
(43) Pub. Date: Dec. 14, 2023

(54) AIR PURIFIER AND OPERATING METHOD THEREOF

(71) Applicant: Samsung Electronics Co., Ltd., Suwon-si (KR)

(72) Inventors: Dongjin HAM, Suwon-si (KR); Hyukjae Kwon, Suwon-si (KR); Mijong KIM, Suwon-si (KR); Sehyeong OH, Suwon-si (KR); Hyun Chul LEE, Suwon-si (KR)

(21) Appl. No.: 17/990,453

(22) Filed: Nov. 18, 2022

(30) Foreign Application Priority Data
Jun. 10, 2022 (KR) 10-2022-0071031

(51) Int. Cl. B01D 53/86; B01D 53/04; B01D 53/34; B01D 53/88

(52) U.S. Cl. CPC B01D 53/869; B01D 53/0438; B01D 53/0454; B01D 53/346; B01D 53/8687; B01D 53/885; B01D 2257/708; B01D 2255/802; B01D 2255/904; B01D 2258/06

(57) ABSTRACT

An air purifier includes a reactor having a hollow shape extending in a first direction, a first purifying portion disposed inside the reactor in a fixed manner, where the first purifying portion has a facing surface perpendicular to the first direction, and includes an adsorbent for adsorbing a pollutant inflowing into the reactor and a first catalytic oxidant for removing a desorbed pollutant, and a heating portion disposed opposite to the facing surface, where the heating portion applies heat to a partial area of the first purifying portion, and is movable with respect to the first purifying portion along a plane perpendicular to the first direction.

### CROSS-REFERENCE TO RELATED APPLICATION

This application claims priority to Korean Patent Application No. 10-2022-0071031, filed on Jun. 10, 2022, and all the benefits accruing therefrom under 35 U.S.C. § 119, the content of which in its entirety is herein incorporated by reference.

### BACKGROUND

### 1. Field

The disclosure relates to an air purifier configured to purify pollutant gas containing pollutant elements such as volatile organic compounds, and a method of purifying air by using the air purifier.

### 2. Description of the Related Art

An air purifier may purify air by capturing or dissolving fine dust and pollutants in gas, e.g., the air. Air purifiers may be applied to industrial dust collectors, building air conditioning and ventilation systems, etc.

According to the recent strengthening of legal regulations on the atmospheric environment, technologies related to processing of malodor components such as ammonia, hydrogen sulfide, etc. and volatile organic compounds, such as toluene, xylene, etc. have been developed actively. A pollutant gas including volatile organic compounds discharged from an emission source may be removed by a preprocessor, an adsorbing portion, and a final oxidizing portion.

### SUMMARY

When volatile organic compounds are removed, the adsorbing capacity of the adsorbent may be limited by organic compounds adsorbed by an adsorbing portion. Heat may be applied to the adsorbing portion to regenerate the adsorbent. In the related art, an adsorbing portion including an adsorbent may be implemented as a rotor having a cylindrical shape. Accordingly, the adsorbing portion may rotate with respect to a heat source configured to apply heat to the adsorbing portion.

The rotation of the adsorbing portion with respect to the heat source may cause a power loss. Furthermore, the performance of pollutant sealing for preventing leakage of a pollutant from the adsorbing portion may be degraded. In addition, as the shape of the adsorbing portion is limited to the cylindrical shape, not only the degree of freedom in designing a space in which the adsorbing portion is arranged may be reduced, but also the adsorption efficiency of the adsorbing portion may be decreased.

Embodiments of the disclosure provide an air purifier including a heat source movable on a two-dimensional (2D) plane with respect to an adsorbing portion including an adsorbent, and a method of purifying air using the air purifier.

Embodiments of the disclosure provide an air purifier including a movable heat source capable of applying heat to a partial area of an adsorbing portion having a wide area, and a method of purifying air using the air purifier.

Embodiments of the disclosure provide an air purifier capable of reducing power consumption for rotation of an adsorbing portion and a method of purifying air using the air purifier.

Embodiments of the disclosure provide an air purifier including an adsorbing portion having various shapes regardless of its position, and a method of purifying air using the air purifier.

Embodiments of the disclosure provide an air purifier having an improved adsorption efficiency of an adsorbing portion by optimizing an area coated with an adsorbent, and a method of purifying air using the air purifier.

Embodiments of the disclosure provide an air purifier capable of preventing leakage of pollutant from an adsorbing portion, and a method of purifying air.

Additional aspects will be set forth in part in the description which follows and, in part, will be apparent from the description, or may be learned by practice of the presented embodiments of the disclosure.

According to an embodiment of the disclosure, an air purifier includes a reactor having a hollow shape extending in a first direction, a first purifying portion disposed inside the reactor in a fixed manner, where the first purifying portion has a facing surface perpendicular to the first direction, and includes an adsorbent for adsorbing a pollutant inflowing into the reactor and a first catalytic oxidant for removing a desorbed pollutant, and a heating portion disposed opposite to the facing surface, where the heating portion applies heat to a partial area of the first purifying portion, and is movable with respect to the first purifying portion along a plane perpendicular to the first direction.

In an embodiment, the air purifier may further include a first slide guide extending in a second direction perpendicular to the first direction, and a first slide portion fixed onto the heating portion and movable in the second direction along the first slide guide.

In an embodiment, the air purifier may further include a second slide guide extending in a third direction perpendicular to the first direction and the second direction, and a second slide portion fixed onto the heating portion and movable in the third direction along the second slide guide.

In an embodiment, the adsorbent may include at least one selected from silica, alumina, carbon-based adsorbents, metal organic frameworks (MOF), zeolite imidazolate framework (ZIF), and zeolite.

In an embodiment, the first catalytic oxidant may include at least one metal selected from Pt, Pd, Rh, Ru, Cu, Mn, Co, Mo, Ti, V, W, Ni, Ag, Au, Fe, Sn, Cr, Zn, Mg, and Ce.

In an embodiment, the first purifying portion may include an adsorbing portion coated with the adsorbent and an oxidizing portion coated with the first catalytic oxidant, and the adsorbing portion and the oxidizing portion may be disposed sequentially in the first direction.

In an embodiment, the air purifier may further include a sensor portion which measures a concentration of the pollutant adsorbed by an adsorbing portion of the first purifying portion, which is coated with the adsorbent.

In an embodiment, the air purifier may further include a controller portion which moves the heating portion along the plane, and the controller portion may control the heating portion to move periodically with a certain time interval.

In an embodiment, the air purifier may further include a controller portion which moves the heating portion along the plane, and the controller portion may control the heating portion to move to a certain position based on the concentration of the pollutant sensed by the sensor portion.

In an embodiment, the first purifying portion may include a supporter in which a plurality of through holes is defined in the first direction.

In an embodiment, a hollow area of the reactor may have a polygonal cross-section or a circular cross-section taken along the plane perpendicular to the first direction, and the facing surface of the first purifying portion may have a shape corresponding to the polygonal cross-section or the circular cross-section of the reactor.

In an embodiment, the air purifier may further include a second purifying portion disposed at the rear of the first purifying portion in the first direction, where the second purifying portion may include a second catalytic oxidant, and a light source which provides incident light of a certain wavelength to the second purifying portion.

In an embodiment, the second purifying potion may include a first second purifying portion and a second second purifying portion which are spaced apart from each other at a certain distance in the first direction, and the light source may be disposed between the first second purifying portion and the second second purifying portion.

In an embodiment, the second catalytic oxidant may include at least one selected from TiO₂, WO₃, SrTiO₃, α-Fe₂O₃, SnO₃, ZnO, BiVO₂, Fe₂O₃, V₂O₃, ZrO₂, CdS, CdSe, GaP, and Si.

In an embodiment, the air purifier may further include a pressurizer disposed at the rear of the reactor, where the pressurizer may apply negative pressure to the inside of the reactor to move the pollutant in the first direction.

According to an embodiment of the disclosure, an operating method of an air purifier includes moving contaminated air to the first purifying portion in the first direction, adsorbing, by the adsorbent, the pollutant included in the contaminated air, moving the heating portion to a certain position on the plane, applying heat to the first purifying portion to desorb the pollutant adsorbed by the adsorbent, and removing the desorbed pollutant by using the first catalytic oxidant.

In an embodiment, the heating portion may move periodically with respect to the first purifying portion with a certain time interval.

In an embodiment, the method may further include measuring a concentration of the pollutant adsorbed by an adsorbing portion of the first purifying portion, which is coated with the adsorbent, and the heating portion may be moved to a certain position based on a measured concentration of the pollutant.

In an embodiment, the adsorbent may include at least one selected from silica, alumina, carbon-based adsorbents, metal organic frameworks (MOF), zeolite imidazolate framework (ZIF), and zeolite.

In an embodiment, the first catalytic oxidant may include at least one metal selected from Pt, Pd, Rh, Ru, Cu, Mn, Co, Mo, Ti, V, W, Ni, Ag, Au, Fe, Sn, Cr, Zn, Mg, and Ce.

In an embodiment, the method may further include removing the pollutant by using a second catalytic oxidant.

In an embodiment, the second catalytic oxidant may include at least one selected from TiO₂, WO₃, SrTiO₃, α-Fe₂O₃, SnO₃, ZnO, BiVO₂, Fe₂O₃, V₂O₃, ZrO₂, CdS, CdSe, GaP, and Si.

### BRIEF DESCRIPTION OF THE DRAWINGS

The above and other features advantages of certain embodiments of the disclosure will be more apparent from the following description taken in conjunction with the accompanying drawings, in which:

FIG. 1 is a schematic diagram of an air purifier according to an embodiment;

FIG. 2 is a block diagram of an air purifier according to an embodiment;

FIG. 3 is a perspective view of a reactor, a first purifying portion, and a heating portion according to an embodiment;

FIG. 4 is a front view of a reactor, a first purifying portion, and a heating portion according to an embodiment;

FIG. 5A is a front view illustrating movement in a second direction of a heating portion with respect to a first purifying portion, according to an embodiment;

FIG. 5B is a front view illustrating movement in a third direction of a heating portion with respect to a first purifying portion, according to an embodiment;

FIG. 5C is a front view illustrating movement in a second direction and a third direction of a heating portion with respect to a first purifying portion, according to an embodiment;

FIG. 6 is a front view of a supporter according to an embodiment;

FIG. 7A is a schematic diagram of an air purifier according to a comparative example;

FIG. 7B is a front view of a supporter according to a comparative example;

FIG. 8 is a perspective view of a reactor, a first purifying portion, a second purifying portion, and a heating portion according to an embodiment; and

FIG. 9 is a flowchart of an operating method of an air purifier according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Embodiments of the disclosure will now be described more fully with reference to the accompanying drawings. In the drawings, like reference numerals in the drawings denote like elements, and sizes of components in the drawings may be exaggerated for clarity and convenience of illustration and description.

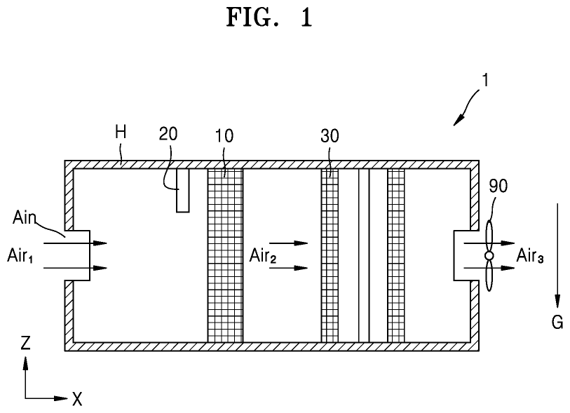

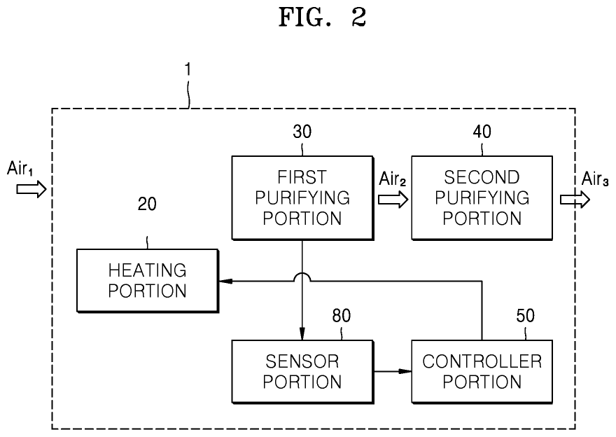

FIG. 1 is a schematic diagram of an air purifier according to an embodiment. FIG. 2 is a block diagram of an air purifier according to an embodiment.

With reference to FIGS. 1 and 2, an air purifier 1 according to an embodiment may include an air inlet Ain into which contaminated air Air₁ flows, a reactor H having a hollow shape extending in a first direction (X direction), a first purifying portion 10 configured to purify the contaminated air Air₁ into first purified air Air₂, a heating portion 20 configured to apply heat to a partial area of the first purifying portion 10, a second purifying portion interconnected with the first purifying portion 10 and configured to purify the first purified air Air₂ into second purified air Air₃, a controller portion 50 configured to control driving of the air purifier 1, a sensor portion 80 configured to measure a concentration of pollutant gas adsorbed by the first purifying portion 10, and a pressurizer 90 arranged (or disposed) at a rear portion of the air purifier 1 and configured to apply pressure to move the contaminated air Air₁.

In an embodiment, the first purifying portion 10 and the second purifying portion may be arranged one after another (or sequentially) in this stated order; however, the disclosure is not limited thereto. In the air purifier 1 according to another embodiment, the second purifying portion 30 and the first purifying portion 10 may be arranged one after another in this stated order.

Herein, the contaminated air Air₁ may refer to a gas mixture including air and at least one selected from fine dust, a water-soluble organic compound (VOCₛₒₗ), and a water-insoluble organic compound (VOCᵢₙₛₒₗ). In an embodiment, for example, the fine dust may include fine dust having a particle size less than or equal to about 10 micrometers (μm) and ultrafine dust having a particle size less than or equal to about 2.5 μm. The water-soluble organic compound VOCₛₒₗ may be a volatile organic compound and may include a gaseous substance which can be captured in water or aqueous solution and removed, e.g., ammonia (NH₃), acetaldehyde (CH₃CHO), and acetic acid (CH₃COOH). The water-insoluble organic compound (VOCᵢₙₛₒₗ) may be a volatile organic compound which is not captured in water or aqueous solution, and may include, for example, benzene (C₆H₆), formaldehyde (CH₂O), toluene (C₆H₅CH₃), etc. However, the disclosure is not limited thereto, and any gas other than the fine dust, the water-soluble organic compound (VOCₛₒₗ), and the water-insoluble organic compound (VOCᵢₙₛₒₗ) may be included in the contamᵢₙated air Air₁. A preprocessor (not shown) may remove components of the contaminated air Air₁ flowing into the air inlet Ain, which may cause a problem to the first purifying portion 10 and the second purifying portion 30, such as a particulate material, etc. In general, the preprocessor (not shown) may include a component configured to remove coarse particles, minute particles, or chemical substances, and accordingly, the contaminated air Air₁ flowing into the air inlet Ain may include a volatile organic compound (VOC).

The air inlet Aᵢₙ may be a passage into which the contaminated air Air₁ enters. According to an embodiment, the air inlet Air₁ may be defined at a front portion of the reactor H in the form of an opening. However, the disclosure is not limited thereto, and the air inlet Ain may be arranged at any position of a front portion of the first purifying portion 10 in the form of an opening. In an embodiment, for example, a pump (not shown) may be arranged at the air inlet Ain, and accordingly, negative pressure may be formed by the pump so that the contaminated air Air₁ flows into the air inlet Ain.

In an embodiment, as illustrated in FIG. 1, where the air inlet Ain, the first purifying portion 10, and the second purifying portion 30 are arranged sequentially or one after another and interconnected with each other, the pressurizer 90, for example, a blower, may be arranged at the rear of (after or subsequent to) the reactor H. Accordingly, by applying the negative pressure to the inside of the reactor H in the first direction (X direction) by the pressurizer 90, the contaminated air Air₁, the first purified air Air₂, and the second purified air Air₃ may be moved along the air inlet Ain, the first purifying portion and the second purifying portion 30 in the first direction (X direction), which is different than the gravity direction G.

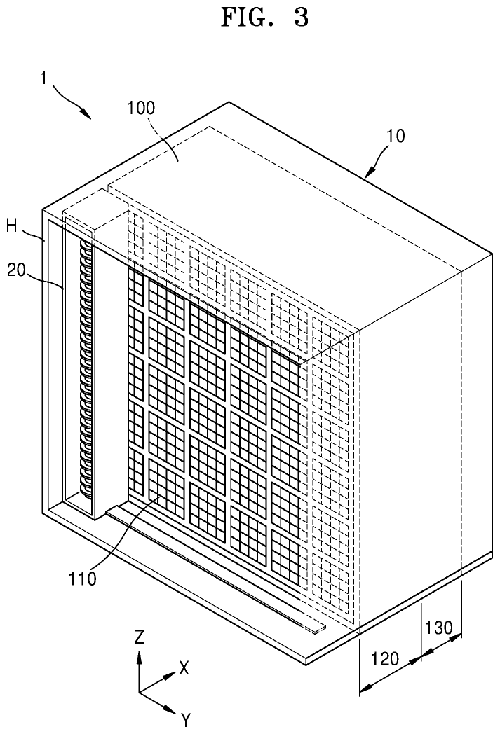

The first purifying portion 10 may adsorb and remove a pollutant included in the contaminated air Air₁, for example, the volatile organic compound (VOC). The first purifying portion 10 according to an embodiment may be arranged in a fixed manner (or fixed at a predetermined position) inside the reactor H. In an embodiment, for example, the first purifying portion 10 may include a facing surface 110 (see FIG. 3) perpendicular to the first direction (X direction) in which the contaminated air Air₁ moves. The contaminated air Air₁ may pass through the facing surface 110 and moves to the rear portion of the reactor H.

The first purifying portion 10 according to an embodiment may include an adsorbent for adsorbing a pollutant included in the contaminated air Air₁ and a first catalytic oxidant for removing the pollutant. Accordingly, when the contaminated air Air₁ passes through the facing surface 110, the pollutant included in the contaminated air Air₁ may be adsorbed and removed by the first purifying portion 10. The adsorbing and removing the pollutant included in the contaminated air Air₁ by using the first purifying portion 10 will be described below in greater detail with reference to FIGS. 3 to 7B.

The heating portion 20 may regenerate the adsorbent included in the first purifying portion 10 by applying heat to a partial area of the first purifying portion 10. The heating portion 20 according to an embodiment may be arranged opposite to the facing surface 110 (see FIG. 3). The heating portion 20 may be arranged movable with respect to the first purifying portion 10 along a plane perpendicular to the first direction (X direction), e.g., a YX plane. Accordingly, the heating portion 20 may be moved to a partial area of the first purifying portion 10 and selectively perform regeneration on the partial area of the first purifying portion 10.

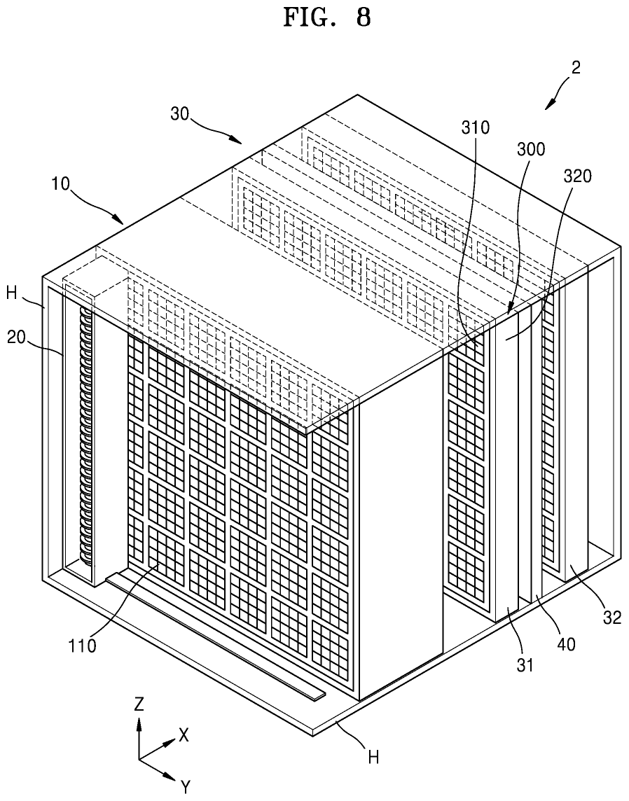

The second purifying portion 30 may additionally remove a remaining pollutant included in the first purified air Air₂, e.g., the volatile organic compound (VOC). The second purifying portion 30 according to an embodiment may be arranged at the rear of the first purifying portion 10. In an embodiment, for example, the second purifying portion 30 may include a facing surface 310 (see FIG. 8) perpendicular to the first direction (X direction) in which the first purified air Air₂ moves. The first purified air Air₂ may pass through the facing surface 310 and moves to the rear portion of the reactor H.

The second purifying portion 30 according to an embodiment may include a second catalytic oxidant for removing a pollutant included in the first purified air Air₂. Accordingly, when the first purified air Air₂ passes through the facing surface 310, the pollutant included in the first purified air Air₂ may be adsorbed and removed. The adsorbing and removing the pollutant included in the first purified air Air₂ by using the second purifying portion 30 will be described below in greater detail with reference to FIG. 8.

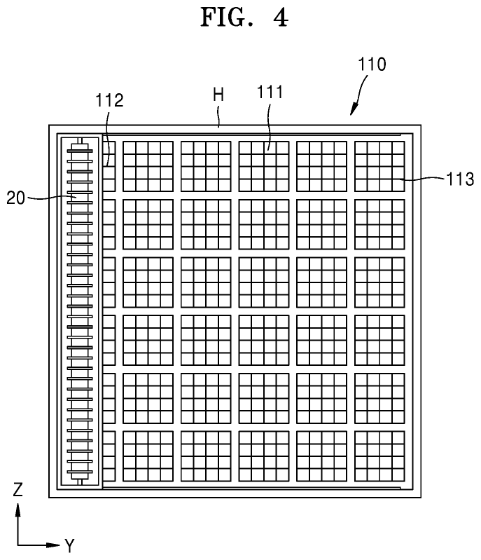

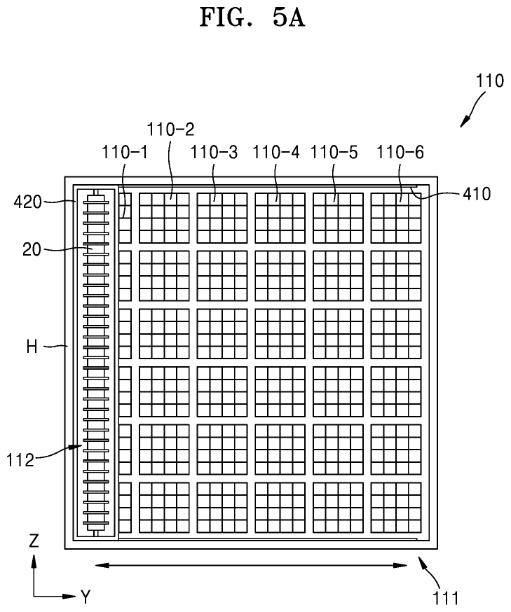

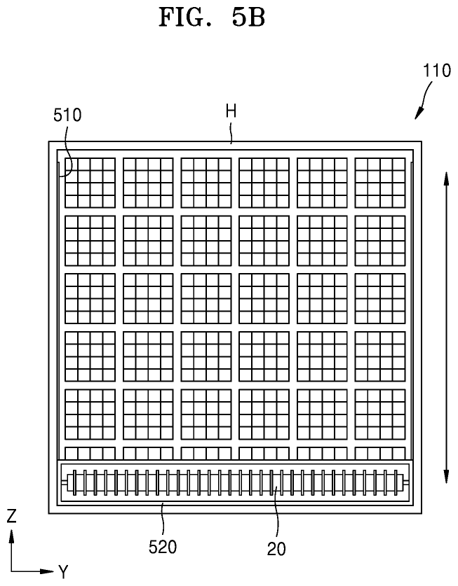

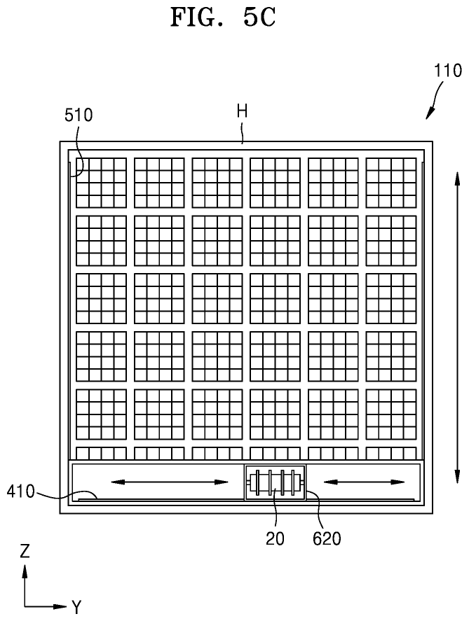

FIG. 3 is a perspective view of a reactor, a first purifying portion, and a heating portion according to an embodiment. FIG. 4 is a front view of a reactor, a first purifying portion, and a heating portion according to an embodiment. FIG. 5A is a front view illustrating movement of a heating portion with respect to a first purifying portion in a second direction, according to an embodiment. FIG. 5B is a front view illustrating movement of a heating portion with respect to a first purifying portion in a third direction, according to an embodiment. FIG. 5C is a front view illustrating movement of a heating portion with respect to a first purifying portion in a second direction and a third direction, according to an embodiment.

With reference to FIGS. 3 and 4, the first purifying portion 10 according to an embodiment may include a supporter 100 in which a plurality of through holes are defined in a direction opposite to the first direction (X direction), and an adsorbing portion 120 coated with an adsorbent, and an oxidizing portion 130 coated with a first catalytic oxidant.

The supporter 100 according to an embodiment may include or be formed of metal foam or ceramic foam, for include ceramic or metal molded body having a honeycomb structure. Moreover, the supporter 100 according to an embodiment may be molded by bending or extruding metal or ceramic; however, the disclosure is not limited thereto.

In an embodiment, for example, the supporter 100 may be arranged in a fixed manner in an accommodation space defined in the reactor H, for example, in a hollow area. The supporter 100 according to an embodiment may be arranged across a whole area of the reactor H along a plane perpendicular to the first direction (X direction) (YZ plane) so that the contaminated air Air₁ moving in the first direction (X direction) does not move to the rear portion of the reactor H without passing through the first purifying portion 10.

In an embodiment, for example, where the hollow area of the reactor H has a polygonal or circular cross-section taken along the plane perpendicular to the first direction (X direction) (YZ plane), the facing surface 110 of the supporter 100 may have a shape corresponding to the polygonal or circular cross-section of the reactor H. In an embodiment, as illustrated in FIG. 4, where the hollow area of the reactor H has a tetragonal cross-section taken along the plane perpendicular to the first direction (X direction) (YZ plane), the facing surface 110 of the supporter 100 may have a tetragonal cross-section corresponding to the tetragonal cross-section of the reactor H.

The adsorbing portion 120 according to an embodiment may be arranged in a front portion of the supporter 100 in the first direction (X direction). In an embodiment, for example, the adsorbing portion 120 may arrange an adsorbent in a through hole area included in the supporter 100. The adsorbent may include, for example, at least one material selected from silica, alumina, carbon-based adsorbents, MOF, ZIF, and zeolite. As for zeolite, natural or synthetic zeolite having a pore size greater than or equal to about 4 angstrom (Å) may be used in general, and by using Y, ZSM-5, or a mixture thereof, aliphatic hydrocarbon, alcohols, ketones, esters, ethers, aromatic hydrocarbon, etc. are adsorbed and concentrated. According to an embodiment, the through hole area included in the supporter 100 may be coated with the adsorbent. The adsorbent may be a molded adsorbing material or a supporter coated or immersed with an adsorbing material.

The oxidizing portion 130 according to an embodiment may arrange a first catalytic oxidant in the through hole area included in the supporter 100. In an embodiment, for example, the first catalytic oxidant may include at least one metal selected from Pt, Pd, Rh, Ru, Cu, Mn, Co, Mo, Ti, V, W, Ni, Ag, Au, Fe, Sn, Cr, Zn, Mg, and Ce to adsorb or catalytic-oxide at a lower temperature a component which is difficult to adsorb. In addition, the first catalytic oxidant may include a form with varying oxidation number of metal. The first catalytic oxidant may be supported by a carrier, and the carrier may include at least one selected from a carbonaceous carrier, a metallic oxide, a metallic carbide, a metallic nitride, and a metallic sulfide. According to an embodiment, the through hole area included in the supporter 100 may be coated with the first catalytic oxidant. The first catalytic oxidant may be a molded adsorbing material or a supporter or carrier coated or immersed with an adsorbing material. The supporter or carrier of the first catalytic oxidant may include a material capable of effectively dispersing components showing catalytic activity in a porous body with high porosity characteristics. Moreover, the carrier or supporter of the first catalytic oxidant for dispersion of catalyst may include a material having a great specific surface area and thermal durability.

The front portion of the supporter 100 according to an embodiment, for example, the facing surface 110, may be divided into at least two functional areas. In an embodiment, for example, the functional areas may include an adsorbing area 111, in which a pollutant included in the contaminated air Air₁ is adsorbed, and a desorbing area 112, in which the adsorbed pollutant is desorbed. According to an embodiment, the pollutant included in the contaminated air Air₁ may be adsorbed by the adsorbent included in the adsorbing portion 120 when passing through the supporter 100. When the concentration of the pollutant adsorbed by the adsorbent is greater than a reference concentration, the pollutant may be desorbed from the adsorbent to regenerate the adsorbent. Heat may be applied to the desorbing area 112 to desorb the pollutant from the adsorbent. Accordingly, the front portion of the supporter 100, for example, the facing surface 110 may be divided into the adsorbing area 111 for adsorbing a pollutant, a desorbing area 112 for desorbing the pollutant by applying heat thereto, a cooling area 113 for cooling the heated desorbing area 112. Accordingly, as the heat is desired to be applied only to the desorbing area 112 of the front portion of the supporter 100 (e.g., the facing surface 110), the heating portion 20 arranged opposite to the facing surface 110 may move with respect to the first purifying portion 10 to face the desorbing area 112.

The heating portion 20 may be arranged opposite to the facing surface 110, and heat may be applied to a partial area of the first purifying portion 10, for example, to the desorbing area 112. According to an embodiment, the heating portion 20 may include at least one selected from a hot air, an electric heater, a plasma heater, and a microwave heater to heat the adsorbent. However, the disclosure is not limited thereto, and the heating portion 20 may include other heating members to apply heat to the desorbing area 112.d According to an embodiment, the desorbing area 112 heated by the heating portion 20 may have a temperature in a range of about 200° C. to about 400° C.; however, the disclosure is not limited thereto.

In an embodiment, as described above, as the heating portion 20 applies heat to a partial area of the facing surface 110, for example, to the desorbing area 112, a heating area of the heating portion 20 may be less than the facing surface 110. In such an embodiment, as the adsorbing area 111, the desorbing area 112, and the cooling area 113 may be changed over time, the heating portion 20 may move along one plane perpendicular to the first direction (X direction) (YZ plane) with respect to the first purifying portion 10, e.g., the facing surface 110.

According to an embodiment, as illustrated in FIG. 5A, the heating portion 20 may be arranged to extend in a third direction (Z direction) which is perpendicular to the first direction (Z direction). In an embodiment, for example, a first slide guide 410 may be arranged to extend in a second direction (Y direction) which is perpendicular to the first direction (X direction). The first slide guide 410 may be fixed onto the reactor H. The heating portion 20 may be fixed onto a first slide portion 420. Moreover, the first slide portion 420 may move along the first slide guide 410 in the second direction (Y direction). Accordingly, as the heating portion 20 moves in the second direction (Y direction), heat may be applied to a partial area of the facing surface 110.

According to an alternative embodiment, as illustrated in FIG. 5B, the heating portion 20 may be arranged to extend in the second direction (Y direction) which is perpendicular to the first direction (Z direction). In an embodiment, for example, a second slide guide 510 may be arranged to extend in the third direction (Z direction) which is perpendicular to the first direction (X direction). The second slide guide 510 may be fixed onto the reactor H. The heating portion 20 may be fixed onto a second slide portion 520. Moreover, the second slide portion 520 may move along the second slide guide 510 in the third direction (Z direction). Accordingly, as the heating portion 20 moves in the third direction (Z direction), heat may be applied to a partial area of the facing surface 110.

In another alternative embodiment, as illustrated in FIG. 5C, the heating portion 20 may be formed smaller than the heating portion 20 illustrated in FIGS. 5A and 5B. In an embodiment, for example, the second slide guide 510 may be arranged to extend in the third direction (Z direction) which is perpendicular to the first direction (X direction). The second slide guide 510 may be fixed onto the reactor H. In an embodiment, for example, the first slide guide 410 may be arranged to extend in the second direction (Y direction) which is perpendicular to the first direction (X direction). The first slide guide 410 may be arranged movable in the third direction (Z direction) with respect to the second slide guide 510. The heating portion 20 may be fixed to a third slide portion 620 and move along a plane (YZ plane) in the second direction (Y direction) or the third direction (Z direction).

In an embodiment, as described above, the heating portion 20 may move along the plane (YZ plane) in the second direction (Y direction) in the third direction (Z direction), and thus, an area heated by the heating portion 20 may be changed as the heating portion moves. In an embodiment, for example, the controller portion 50 may control an area of the facing surface 110 to be heated by the heating portion 20 by moving the heating portion 20 to the desorbing area 112 which needs to be heated.

According to an embodiment, the controller portion 50 may control a driving portion (not shown) to move the heating portion 20 on the plane (YZ plane). In an embodiment, for example, the adsorbing area 111, the desorbing area 112, and the cooling area 113 may be periodically repeatedly defined on the facing surface 110 with a certain (predetermined or constant) time interval. The controller portion 50 may control the heating portion 20 to periodically move along a predetermined path on the plane (YZ plane). In an embodiment, for example, the time interval with which the heating portion moves may be predetermined in consideration of time interval of saturation of the adsorbent based on the adsorption capacity of the adsorbent included in the adsorbing portion 120 and the concentration of the pollutant included in the contaminated air Ain.

In an embodiment, for example, the facing surface 110 illustrated in FIG. 5A may be divided into 6 areas, i.e., a first area 110-1, a second area 110-2, a third area 110-3, a fourth area 110-4, a fifth area 110-5, and a sixth area 110-6. The first area 110-1 arranged to face the heating portion 20 may become the desorbing area 112, and the second area 110-2 to the sixth area 110-6 may be the adsorbing area 111. After a predetermine time period, the controller portion 50 may move the heating portion 20 in the second direction (Y direction) so that the heating portion 20 faces the second area 110-2. When the heating portion 20 faces the second area 110-2, the second area 110-2 arranged to face the heating portion 20 may be the desorbing area 112, and the third area 110-3 to the sixth area 110-6 may be the adsorbing area 111. In addition, the first area 110-1 may become the cooling area 113 for cooling the heated first area 110-1. The controller portion 50 may move the heating portion 20 to the third area 110-3 to the sixth area 110-6 over time, and the adsorbing area 111, the desorbing area 112, and the cooling area 113 may be periodically repeatedly defined by the first area 110-1 to the sixth area 110-6 with a certain time interval.

According to an embodiment, where the air purifier 1 is a large air purifier, the concentration of pollutant included in the contaminated air Air₁ flowing into the facing surface 110 may be inconstant. Accordingly, the concentration of pollutant may vary in partial areas of the facing surface 110. Thus, the regeneration process may be performed on the adsorbent by applying heat to an area of the facing surface 110 which has a high concentration of pollutant.

According to an embodiment, the sensor portion 80 may be arranged at the first purifying portion 10 and measure a concentration of the pollutant adsorbed by the adsorbing portion. In an embodiment, for example, the sensor portion 80 may be provided in plural, and a plurality of sensor portions 80 may respectively be arranged in the plurality of areas of the facing surface 110. In an embodiment, for example, six sensor portions 80 may be respectively arranged at the first area 110-1 to the sixth area 110-6 illustrated in FIG. 5A. The sensor portion 80 may transmit the concentration of pollutant in each area to the controller portion 50.

When the concentration of pollutant in the third area 110-3 is high compared to other areas, the controller portion 50 may move the heating portion 20 in the second direction (Y direction) so that the heating portion 20 faces the third area 110-3. Accordingly, the third area 110-3 arranged to face the heating portion 20 may be the desorbing area 112, and the first area 110-1, the second area 110-2, and the fourth area 110-4 to the sixth area 110-6 may be the adsorbing area 111. After the heating of the third area 110-3 is completed, the heating portion 20 may be moved to face one of the first area 110-1, the second area 110-2, and the fourth area 110-4 to the sixth area 110-6 based on a concentration of pollutant sensed by the sensor portion 80. Accordingly, the adsorbing area 111, the desorbing area 112, and the cooling area 113 may be selectively repeatedly defined by the first area 110-1 to the sixth area 110-6 based on the concentration of pollutant.

The oxidizing portion 130 may oxidize and remove a pollutant which is not adsorbed by the adsorbing portion 120 or desorbed after being adsorbed by the adsorbing portion 120, for example, the volatile organic compound (VOC). In an embodiment, for example, the oxidizing portion 130 may be coated with the first catalytic oxidant to chemical-oxidize or catalytic-oxide at a lower temperature state which are difficult to adsorb. Accordingly, the volatile organic compound (VOC) which has flowed into the oxidizing portion 130 may be resolved into carbon dioxide and water in a relatively low temperature state, e.g., at a temperature in a range of about 100° C. to about 400° C. as shown in the following Reaction Formula 1.

CₓH_{y}O_{z}+O₂→CO₂+H₂O [Reaction Formula 1]

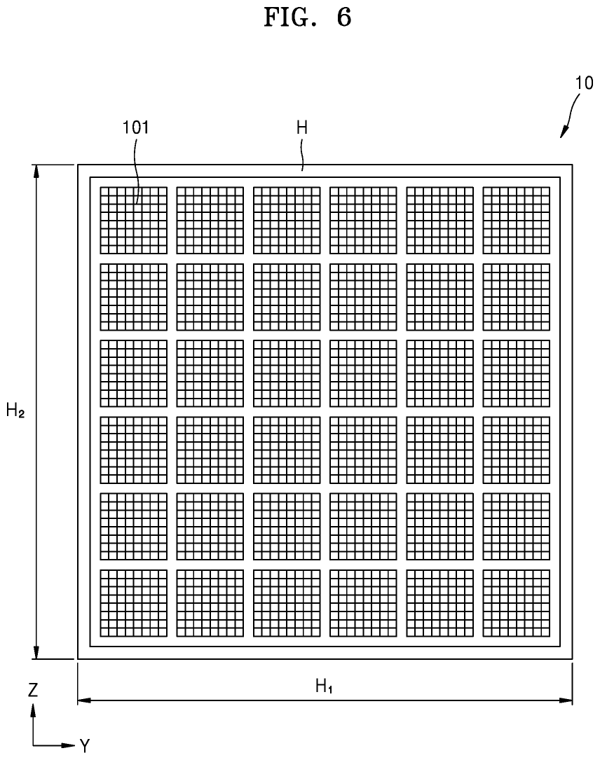

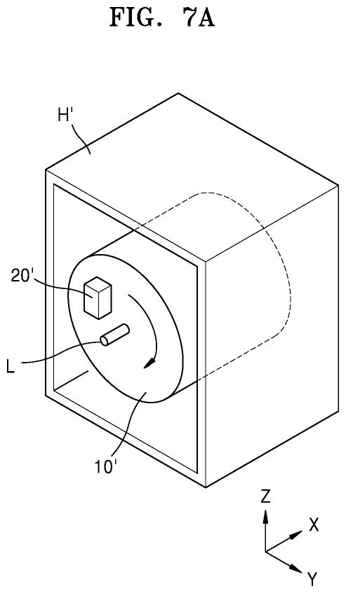

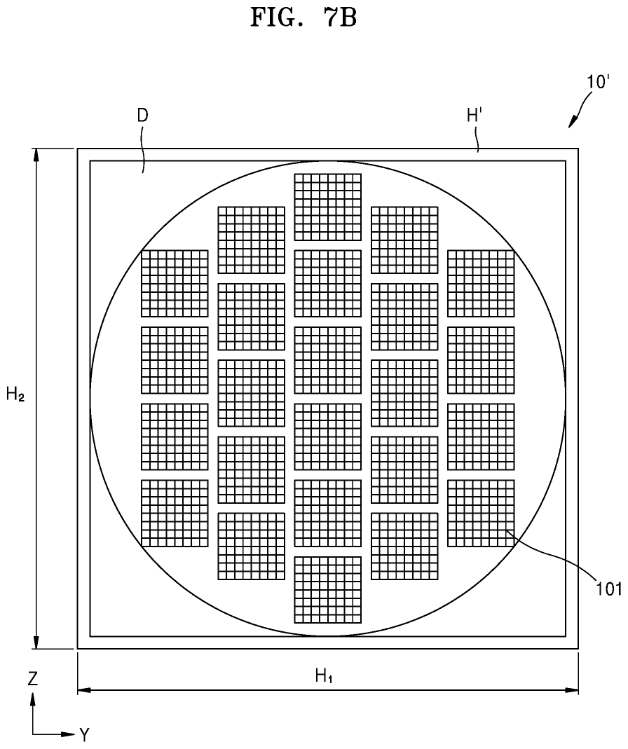

FIG. 6 is a front view of a supporter according to an embodiment. FIG. 7A is a schematic diagram of an air purifier according to a comparative example. FIG. 7B is a front view of a supporter according to a comparative example.

As shown in FIGS. 3 and 6, the first purifying portion 10 according to an embodiment may be fixed onto the reactor H. The heating portion 20 may move along the plane (YZ plane) with respect to the first purifying portion 10.

With reference to FIGS. 7A to 7B, in a comparative example or a conventional air purifier, a purifying portion 10′ corresponding to the first purifying portion 10 of the disclosure is arranged rotatably around an axis L with respect to a reactor H′, and a heating portion 20′ is fixed onto the reactor H′ and faces the purifying portion 10′. In the comparative example, as the purifying portion 10′ is arranged rotatably with respect to the reactor H′, the sealing between the reactor H′ and the purifying portion 10′ may be difficult to perform. Accordingly, the contaminated air flowing through the purifying portion 10′ may leak from the purifying portion 10′.

In the comparative example, when the purifying portion 10′ rotates around an axis with respect to the reactor H′, the purifying portion 10′ may be implemented as a rotor having a cylindrical shape in consideration of side effects of inertia. In this case, there may be a discrepancy between a cross-section of the purifying portion 10′ along a YZ plane and a cross-section of the reactor H′. For example, as illustrated in FIG. 7B, the reactor H′ may have a rectangular cross-section while the purifying portion 10′ has a circular cross-section. Accordingly, as the purifying portion 10′ is not arranged in a partial area D of the reactor H′, there may be a dead space. An area occupied by the purifying portion 10′ in a whole area of the reactor H′ may be reduced, which lead to degraded purification performance.

In an embodiment, for example, as illustrated in FIG. 6, where the reactor H has a horizontal length H₁ and vertical length H₂ of 1 m, total 36 supporter modules 101 having a honeycomb shape of 150 millimeters (mm)×150 mm including cordierite of Ceracomb Co., Ltd. may be arranged. An area of the first purifying portion 10 through which the contaminated air passes may be about 0.81 m². When the contaminated air is introduced at about 1.2 meter per second (m/s), the line velocity of the contaminated air passing through the first purifying portion 10 may be about 1.48 m/s.

In the comparative example, as illustrated in FIG. 7B, where the reactor H′ has a horizontal length H₁ and vertical length H₂ of 1 m, and the purifying portion 10′ in a cylindrical shape having a diameter of 1 m is arranged at the reactor H′, total 24 supporter modules 101 having a honeycomb shape of 150 mm×150 mm including cordierite of Ceracomb Co., Ltd. may be arranged. An area of the purifying portion 10′ through which the contaminated air passes may be about 0.54 m². When the contaminated air is introduced at about 1.2 m/s, the line velocity of the contaminated air passing through the purifying portion 10′ may be about 2.22 m/s.

As described above, in the first purifying portion 10 according to an embodiment, the area through the contaminated air passes is relatively wider than that of the purifying portion 10′ according to the comparative example. Accordingly, the line velocity of the contaminated air passing through the first purifying portion 10 may be slower than that of the contaminated air passing through the purifying portion 10′. In an embodiment, the purification performance is improved as the time during which the contaminated air passing through the first purifying portion 10 is in contact with the adsorbent included in the first purifying portion 10 increases.

FIG. 8 is a perspective view of a reactor, a first purifying portion, a second purifying portion, and a heating portion according to an embodiment.

With reference to FIG. 8, an air purifier 2 according to an embodiment may include the first purifying portion 10, the heating portion 20, the second purifying portion 30, a light source 40, the controller portion 50, the sensor portion 80, and the pressurizer 90. In the embodiment of FIG. 8, the components except for the second purifying portion 30 and the light source 40, e.g., the first purifying portion 10, the heating portion 20, the controller portion 50, the sensor portion 80 and the pressurizer 90, are substantially the same as those described above with reference to FIGS. 2 and 3, and thus any repetitive detailed descriptions thereof will be omitted.

The second purifying portion 30 may include a supporter 300 with a plurality through holes defined in the first direction (X direction) and a photooxidizing portion 320 coated with a second catalytic oxidant. The supporter 300 according to an embodiment may include or be formed of metal foam or ceramic foam, for include ceramic or metal molded body having a honeycomb structure. Moreover, the supporter 300 according to an embodiment may be molded by bending or extruding metal or ceramic; however, the disclosure is not limited thereto.

In an embodiment, for example, the supporter 300 may be arranged in a fixed manner in an accommodation space defined in the reactor H, for example, in a hollow area. The supporter 300 according to an embodiment may be arranged across a whole area of the reactor H along a plane perpendicular to the first direction (X direction) (YZ plane) so that the first purified air Air₂ moving in the first direction (X direction) does not move to the rear portion of the reactor H without passing through the second purifying portion 30.

The photooxidizing portion 320 according to an embodiment may arrange the second catalytic oxidant in the through hole area included in the supporter 300. In an embodiment, for example, the second catalytic oxidant may be a material capable of converting optical energy into chemical energy for catalytic oxidation, and may include, for example, at least one selected from TiO₂, WO₃, SrTiO₃, α-Fe₂O₃, SnO₃, BiVO₂, Fe₂O₃, V₂O₃, ZrO₂, ZnO, CdS, CdSe, GaP, and Si or a metallic oxide thereof, and a mixture of metal and metallic oxide. According to an embodiment, the through hole area included in the supporter 300 may be coated with the second catalytic oxidant. The second catalytic oxidant may be a molded adsorbing material or a supporter or carrier coated or immersed with an adsorbing material. The supporter or carrier of the second catalytic oxidant may include a material capable of effectively dispersing components showing catalytic activity in a porous body with high porosity characteristics.

In an embodiment, the light source 40 may provide incident light of a certain wavelength, for example, ultraviolet light, to the second purifying portion 30. In such an embodiment, when the light radiated from the light source 40 is incident on the second catalytic oxidant, the second catalytic oxidant may accept electrons from the volatile organic compound (VOC). Accordingly, the volatile organic compound (VOC) may be oxidative-dissolved, and may be oxidized into water (H₂O) and carbon dioxide (CO₂) and removed. As described above with reference to FIGS. 6 to 7B, when the line velocity of the first purified air Air₂ which passed through the first purifying portion 10 decreases, the time during which the first purified air Air₂ remains at the second purifying portion 30 may be increased. Accordingly, in an embodiment, as the time during which the pollutant is oxidized and removed in the second purifying portion 30 increases, the pollutant removal efficiency may be improved.

According to an embodiment, the second purifying portion 30 may be provided in plural as illustrated in FIG. 8. In an embodiment, for example, the second purifying portion 30 may include a first second purifying portion 31 and a second second purifying portion 32 spaced apart from each other in the first direction (X direction) at a certain distance. The light source 40 may be arranged between the first second purifying portion 31 and the second second purifying portion 32 and provide incident light of a certain wavelength to the second catalytic oxidant included in the first second purifying portion 31 and the second second purifying portion 32. As the light radiated from the light source 40 is incident onto the first second purifying portion 31 and the second second purifying portion 32, the efficiency of the light source 40 may be improved.

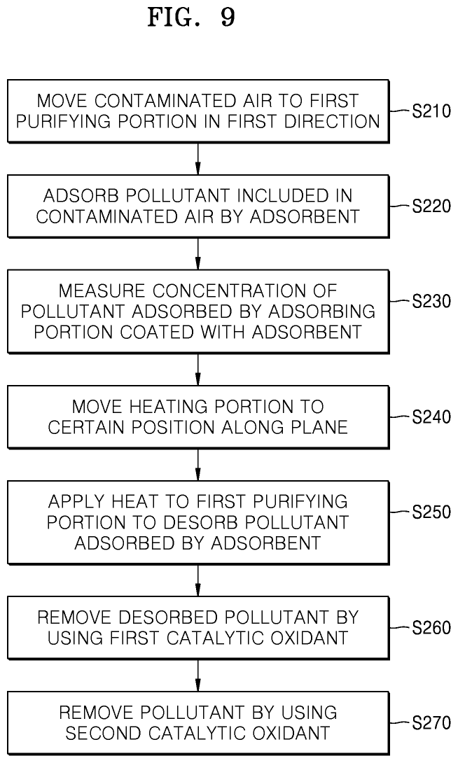

FIG. 9 is a flowchart of an operating method of an air purifier according to an embodiment.

With reference to FIG. 9, in an operating method of an air purifier according to an embodiment, the contaminated air Air₁ may move to the first purifying portion 10 in the first direction (X direction). A preprocessor (not shown) may remove components of the contaminated air Air₁ flowing into the air inlet Ain, which may cause a problem to the first purifying portion 10 and the second purifying portion 30, such as a particulate material, etc. (S210). In general, the preprocessor (not shown) may include a component configured to remove coarse particles, minute particles, and chemical substances, and accordingly, the contaminated air Air₁ flowing into the air inlet Air₁ may include a volatile organic compound (VOC).

Then, the pollutant included in the contaminated air Air₁ may be adsorbed by the adsorbent. The adsorbing portion 120 according to an embodiment may be arranged in a front area of the supporter 100 in the first direction (X direction) (S220). In an embodiment, for example, the adsorbing portion 120 may arrange an adsorbent in a through hole area included in the supporter 100. The adsorbent may adsorb a pollutant included in the contaminated air Air₁, for example, the volatile organic compound (VOC).

Then, the concentration of the pollutant adsorbed at the adsorbing portion 120 coated with the adsorbent may be measured. According to an embodiment, the sensor portion 80 may be arranged at the first purifying portion 10 and measure a concentration of the pollutant adsorbed by the adsorbing portion (S230). In an embodiment, for example, the sensor portion 80 may be provided in plural, and a plurality of sensor portions 80 respectively are arranged in the plurality of areas of the facing surface 110. The sensor portion 80 may measure and transmit the concentration of pollutant in the plurality of areas to the controller portion 50. However, the disclosure is not limited thereto, and the operation measuring the concentration of the pollutant adsorbed by the adsorbing portion 120 may be omitted.

The heating portion 20 may be moved to a certain position along a plane (YZ plane). According to an embodiment, the controller portion 50 may move the heating portion 20 to a certain position along the plane (YZ plane) (S240). At this time, the position to which the heating portion 20 is moved by the controller portion 50 may be periodically changed with a certain time interval. According to another embodiment, the controller portion 50 may move the heating portion 20 based on the concentration of pollutant measured by the sensor portion 80.

Then, heat may be applied to the first purifying portion 10 to desorb the pollutant adsorbed by the adsorbent. According to an embodiment, the heating portion 20 may be arranged opposite to the facing surface 110, and may apply heat to a partial area of the first purifying portion 10, e.g., the desorbing area 112 (S250). According to an embodiment, the heating portion 20 may heat the desorbing area 112 at a temperature in a range of about 200° C. to about 400° C. However, the disclosure is not limited thereto, and the heating temperature may be changed or modified.

The desorbed pollutant may be removed by using the first catalytic oxidant (S260). According to an embodiment, the oxidizing portion 130 may oxide and remove a pollutant which is not adsorbed by the adsorbing portion 120 or desorbed after being adsorbed by the adsorbing portion 120, e.g., the volatile organic compound (VOC). In an embodiment, for example, the oxidizing portion 130 may be coated with the first catalytic oxidant to chemical-oxidize or catalytic-oxide at a lower temperature state which are difficult to adsorb. Accordingly, the volatile organic compound (VOC) which has flowed into the oxidizing portion 130 may be oxidized into water (H₂O) and carbon dioxide (CO₂) in a relatively low temperature state, e.g., at a temperature in a range of about 100° C. to about 400° C. and removed.

Then, the pollutant may be removed by using the second catalytic oxidant (S270). According to an embodiment, the light source 40 may provide incident light of a certain wavelength, e.g., ultraviolet light, to the second purifying portion 30. When the light radiated from the light source 40 according to an embodiment is incident on the second catalytic oxidant, the second catalytic oxidant may accept electrons from the volatile organic compound VOC. Accordingly, the volatile organic compound (VOC) may be oxidative-dissolved, and may be oxidized into water (H₂O) and carbon dioxide (CO₂) and removed.

According to embodiments of the air purifier and the method of purifying air using the air purifier, as described above, power consumption may be reduced by including the heat source which is movable on a 2D plane with respect to the adsorbing portion including the adsorbent without rotating the adsorbent.

In such embodiments, as the adsorbing portion may have various areas and shaped regardless of its position, the degree of freedom in designing may be improved.

In such embodiments, as the adsorbing portion may have various areas and shapes, an area coated with the adsorbent may be optimized, and the adsorption efficiency may be increased.

In such embodiments, as the heat source moves without rotating the adsorbing portion, the sealing performance of the adsorbing portion may be improved.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An air purifier comprising:
a reactor having a hollow shape extending in a first direction;
a first purifying portion disposed inside the reactor in a fixed manner, wherein the first purifying portion has a facing surface perpendicular to the first direction, and includes an adsorbent for adsorbing a pollutant inflowing into the reactor and a first catalytic oxidant for removing a desorbed pollutant; and
a heating portion disposed opposite to the facing surface of the first purifying portion, wherein the heating portion applies heat to a partial area of the first purifying portion, and is movable with respect to the first purifying portion on a plane perpendicular to the first direction.

2. The air purifier of claim 1, further comprising:
a first slide guide extending in a second direction perpendicular to the first direction; and
a first slide portion fixed onto the heating portion and movable in the second direction along the first slide guide.

3. The air purifier of claim 2, further comprising:
a second slide guide extending in a third direction perpendicular to the first direction and the second direction; and
a second slide portion fixed onto the heating portion and movable in the third direction along the second slide guide.

4. The air purifier of claim 1, wherein the adsorbent includes at least one selected from silica, alumina, carbon-based adsorbents, metal organic frameworks, zeolite imidazolate framework, and zeolite.

5. The air purifier of claim 1, wherein the first catalytic oxidant includes at least one metal selected from Pt, Pd, Rh, Ru, Cu, Mn, Co, Mo, Ti, V, W, Ni, Ag, Au, Fe, Sn, Cr, Zn, Mg, and Ce.

6. The air purifier of claim 1, wherein
the first purifying portion comprises an adsorbing portion coated with the adsorbent and an oxidizing portion coated with the first catalytic oxidant, and
the adsorbing portion and the oxidizing portion are disposed sequentially in the first direction.

7. The air purifier of claim 1, further comprising:
a sensor portion which measures a concentration of the pollutant adsorbed by an adsorbing portion of the first purifying portion, which is coated with the adsorbent.

8. The air purifier of claim 1, further comprising:
a controller portion which moves the heating portion on the plane,
wherein the controller portion controls the heating portion to move periodically with a certain time interval.

9. The air purifier of claim 7, further comprising:
a controller portion which moves the heating portion on the plane,
wherein the controller portion controls the heating portion to move to a certain position based on the concentration of the pollutant sensed by the sensor portion.

10. The air purifier of claim 1, wherein the first purifying portion comprises a supporter in which a plurality of through holes is defined in the first direction.

11. The air purifier of claim 1, wherein
a hollow area of the reactor has a polygonal cross-section or a circular cross-section taken along the plane perpendicular to the first direction, and
the facing surface of the first purifying portion has a shape corresponding to the polygonal cross-section or the circular cross-section of the reactor.

12. The air purifier of claim 1, further comprising:
a second purifying portion disposed at the rear of the first purifying portion in the first direction, wherein the second purifying portion includes a second catalytic oxidant; and
a light source which provides incident light of a certain wavelength on the second purifying portion.

13. The air purifier of claim 12, wherein
the second purifying potion comprises a first second purifying portion and a second second purifying portion which are spaced apart from each other at a certain distance in the first direction, and
the light source is disposed between the first second purifying portion and the second second purifying portion.

14. The air purifier of claim 12, wherein the second catalytic oxidant includes at least one selected form TiO₂, WO₃, SrTiO₃, α-Fe₂O₃, SnO₃, ZnO, BiVO₂, Fe₂O₃, V₂O₃, ZrO₂, CdS, CdSe, GaP, and Si.

15. The air purifier of claim 1, further comprising:
a pressurizer disposed at the rear of the reactor, wherein the pressurizer applies negative pressure to an inside of the reactor to move the pollutant in the first direction.

16. An operating method of the air purifier of claim 1, the operating method comprising:
moving contaminated air to the first purifying portion in the first direction;
adsorbing, by the adsorbent, the pollutant included in the contaminated air;
moving the heating portion to a certain position on the plane;
applying heat to the first purifying portion to desorb the pollutant adsorbed by the adsorbent; and
removing the desorbed pollutant by using the first catalytic oxidant.

17. The operating method of claim 16, wherein the heating portion moves periodically with respect to the first purifying portion with a certain time interval.

18. The operating method of claim 17, further comprising:
measuring a concentration of the pollutant adsorbed by an adsorbing portion of the first purifying portion, which is coated with the adsorbent,
wherein the heating portion is moved to a certain position based on a measured concentration of the pollutant.

19. The operating method of claim 16, wherein the adsorbent includes at least one selected from silica, alumina, carbon-based adsorbents, metal organic frameworks, zeolite imidazolate framework, and zeolite.

20. The operating method of claim 16, wherein the first catalytic oxidant includes at least one metal selected from Pt, Pd, Rh, Ru, Cu, Mn, Co, Mo, Ti, V, W, Ni, Ag, Au, Fe, Sn, Cr, Zn, Mg, and Ce.

21. The operating method of claim 16, further comprising:
removing the pollutant by using a second catalytic oxidant.

22. The operating method of claim 21, wherein the second catalytic oxidant includes at least one selected from TiO₂, WO₃, SrTiO₃, α-Fe₂O₃, SnO₃, ZnO, BiVO₂, Fe₂O₃, V₂O₃, ZrO₂, CdS, CdSe, GaP, and Si.
